(19) United States
(12) Patent Application Publication
(10) Pub. No.: US 2004/0127205 A1
(43) Pub. Date: Jul. 1, 2004

(54) Over the air maintenance of mobile station telephone directories

(76) Inventor: Sanjeev Mahajan, Naperville, IL (US)

Correspondence Address: Richard J. Minnich, Fay, Sharpe, Fagan, Minnich & McKee, LLP, Seventh Floor, 1100 Superior Avenue, Cleveland, OH, 44114, US

(21) Appl. No.: 10/331,393

(22) Filed: Dec. 30, 2002

(51) Int. Cl. H04M 3/00; H04B 7/00; H04Q 7/20

(52) U.S. Cl. 455/418; 455/419; 455/517

(57) ABSTRACT

A method of updating data in an electronic database on a mobile station (MS) (20) includes: establishing a first connection with a user over a data network (50); and, receiving data to be entered into the electronic database from the user (10) via the first connection. The received data is forwarded to an over-the-air function (OTAF) server (60), and a second connection is established over a wireless air interface (26) between the MS (20) and a base station (BS) (24) of a cellular telecommunications network (22). The data is transmitted from the OTAF server (60) to the MS (20) via the second connection such that the data is entered into the electronic database.

### FIELD

The present invention relates to the art of wireless telecommunications. It find particular application in conjunction with mobile stations (MS) of a cellular telecommunications network, and will be described with particular reference thereto. However, it is to be appreciated that the present invention is also amenable to other like applications.

### BACKGROUND

An MS (e.g., a mobile telephone, wireless personal digital assistant (PDA), wireless equipped portable or laptop computer, etc.) is often provisioned with a electronic directory into which a user selectively programs or otherwise stores desired telephone numbers and other contact information, e.g., names, addresses, etc. Various such electronic directories and their implementations are commonly known. However, entry of information into the electronic directory can be cumbersome and time consuming, especially in the case of mobile telephones and PDAs which can have limited data input devices as compared to a full keyboard. For example, in a mobile telephone, information is commonly entered into the electronic directory using the mobile telephone's keypad, typically containing only twelve keys (i.e., keys 0-9, an asterisk key, and a pound key). Accordingly, entering different letters and/or other non-numeric text often involves carrying out various combinations of multiple keystrokes for each character to be entered.

In addition to maintaining an electronic directory on their MS, a user may also maintain another similar directory, e.g., on their personal or desk top computer, on another MS, or on some other device. Such a user often desires to have both directories contain the same information, i.e., it is desired that the electronic directories be synchronized to match one another. Namely, it is often desired that the one with the oldest information be updated to match the one with the most current information. One approach to achieving this goal involves the direct connection of the two devices, e.g., through a cable or other data transfer interface. This approach, however, can be undesirable insomuch as there are costs associated with providing and/or purchasing the additional cable or interface equipment.

The present invention contemplates a new and improved method and/or system which overcomes the above-referenced problems and others.

### SUMMARY

In accordance with an aspect of the present invention, a method of updating data in an electronic database on a mobile station (MS) is provided. The method includes: establishing a first connection with a user over a data network; receiving data to be entered into the electronic database from the user via the first connection; forwarding the received data to an over-the-air function (OTAF) server; establishing a second connection over a wireless air interface between the MS and a base station (BS) of a cellular telecommunications network; and, transmitting the data from the OTAF server to the MS via the second connection such that the data is entered into the electronic database. The second connection between the MS and BS can be established at the same time or at a later time.

In accordance with another aspect of the present invention, a system is provided for updating data in an electronic database on a mobile station (MS). The system includes receiving means for receiving from a user data to be entered into the electronic database. The data is received via a first connection established with the user over a data network. The received data is forwarded to an over-the-air function (OTAF) server in operative communication with the receiving means. A cellular telecommunications network includes a base station (BS), and establishes a second connection over a wireless air interface between the MS and the BS. The data is transmitted from the OTAF server to the MS via the second connection such that the data is entered into the electronic database.

In accordance with yet another aspect of the present invention, a method of maintaining an electronic directory on a mobile station (MS) includes obtaining data in the electronic directory from the MS via a wireless air interface between the MS and a base station (BS) of a wireless telecommunications network, and providing the obtained data for selective modification. The method also includes returning the selectively modified data to the MS via the wireless air interface between the MS and the BS of the wireless telecommunications network such that the returned data is entered into the electronic database.

One advantage of the present invention is the ability to provide entry and/or updating of information into a telephone directory of a mobile station.

Another advantage of the present invention is the ability to provide synchronization between two telephone directories without a cable therebetween.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention. Further, it is to be appreciated that the drawings are not to scale.

FIG. 1 is a diagrammatic illustration showing an exemplary communications network configuration in accordance with and/or suitable for practicing aspects of the present invention.

FIG. 2 is a flow chart showing an exemplary electronic directory updating process for a mobile station in accordance with aspects of the present invention.

FIG. 3 is a flow chart showing an exemplary electronic directory data entry process for a mobile station in accordance with aspects of the present invention.

### DETAILED DESCRIPTION OF PREFERRED EMBODIMENTS

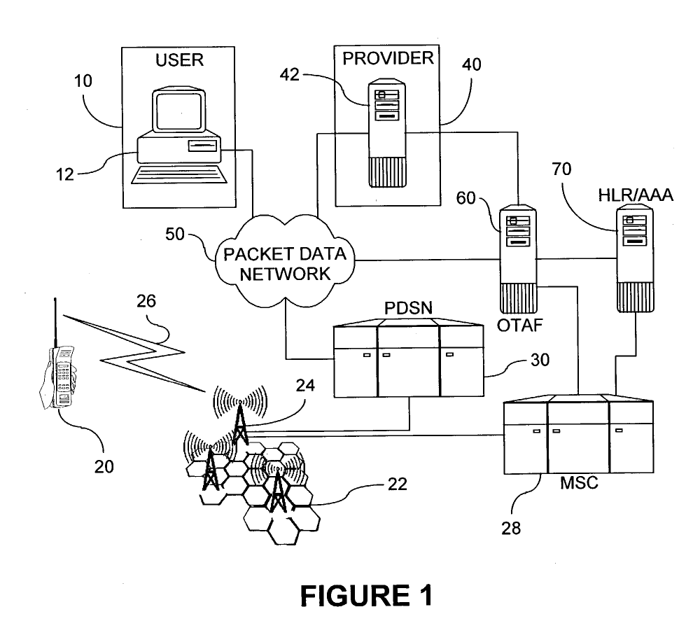

With reference to FIG. 1, a user 10 operates a computer 12 to create, maintain and/or otherwise manage an electronic directory on a mobile station (MS) 20. As shown, the MS 20 operates within a cellular telecommunications network 22 that includes a base station (BS) 24 with which the MS 20 operatively connects via a wireless air interface 26. A mobile switching center (MSC) 28 and packet data serving node (PDSN) 30 interface with the network 22 in the usual manner.

The computer 12 is optionally a general computer or workstation which runs one or more client programs or applications resident thereon or elsewhere stored. Preferably, at least one of the clients or applications on the computer 12 also incorporates an electronic directory and/or is suitable for creating, editing, storing or otherwise managing the same. For identification purposes herein, the electronic directory on the MS 20 is nominally referred to as the first directory, and electronic directory on the computer 12 is nominally referred to as the second directory. The client may be a database or spreadsheet client, a contact management client, an address book client, a phonebook client, an organizer client, or another like client or application as is commonly known for creating, storing and/or editing electronic directories. Alternately, the computer 12 may be another appropriate device, e.g., a PDA, another MS, etc., which incorporates the second directory. Similarly, while shown as a mobile telephone, the MS 20 may be any other suitable type of MS which incorporates the first directory.

Employing a suitable web browser or like client running on the computer 12 and a suitable protocol (e.g., transmission control protocol/internet protocol (TCP/IP)), the user 10 connects to a web server 42 of a service provider 40, e.g., over the Internet 50 or some other data network. Optionally, the service provider 40 provides mobile service to the user 10 for the MS 20. Alternately, the service provider 40 may be a contracted independent third party. Once connected to the server 42, the user 10 logs on to their subscriber account to selectively create, access, update, modify and/or otherwise manipulate the first directory on MS 20.

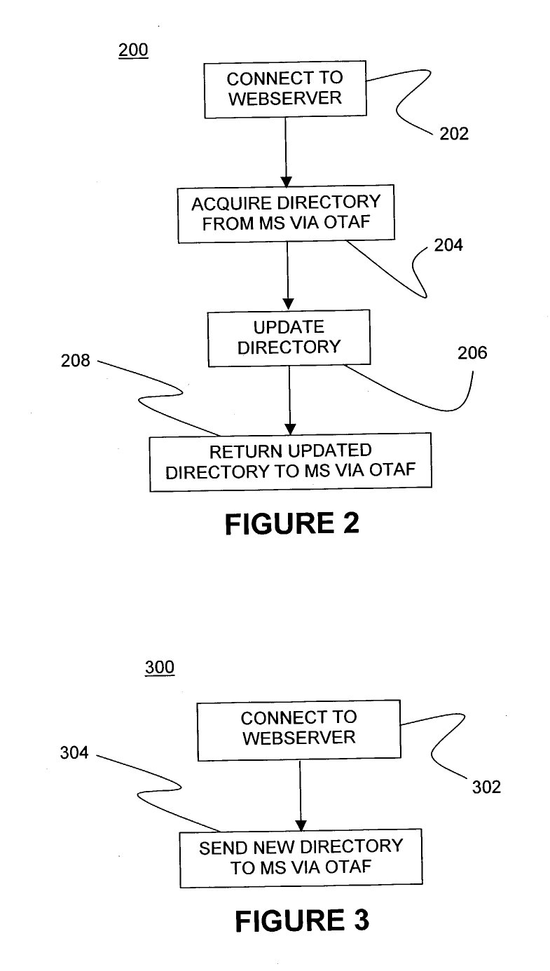

With reference also to FIG. 2, a process 200 whereby the user 10 updates an existing first directory is illustrated and now described for exemplary purposes. In short, after connecting to the server 42 at step 202, at step 204 the first directory is acquired from the MS 20, it is updated or otherwise edited using an electronic directory management client, application or other suitable tool at step 206, and then the revised first directory is returned to the MS 20 at step 208.

In addition to optionally providing known over-the-air service provisioning and over-the-air parameter administration (OTASP and OTAPA) functions for the MS 20 in the usual manner, an over-the-air function (OTAF) server 60 also provides the electronic directory management functions described herein. More specifically, in response to a query, command or other instruction received from the computer 12 requesting the first directory, the server 42 sends an acquire message to the OTAF server 60 responsible for the MS 20. Upon receipt of the acquire message, the OTAF server 60 accesses the home location register (HLR) and/or authentication, authorization and accounting (AAA) server 70 to locate and/or identify the MS 20. The HLR/AAA server 70 carries out the HLR and AAA functions in a suitable manner.

Once the MS 20 has been located and/or identified and any appropriate authorizations have been established, the OTAF server 60 sends a message to the MS 20 requesting acquisition of the first directory. The MS 20 response by returning to the OTAF server 60 a message containing the first directory along with details of the manner in which data is structured therein. In turn, the OTAF server 60 forwards the same on to the provider's server 42.

Optionally, the server 42 reformats the received directory into a format specified by the user 10, e.g., to be compatible with and/or recognized by the electronic directory management client being employed on the computer 12. The properly formatted directory is then downloaded to the user's computer 12. The user 10 is then free to selective edit or otherwise update the first directory using the appropriate client, application or tool on the computer 12. Optionally, the received first directory may be synchronized with the second directory on the computer 12. Alternately, rather than being downloaded to the computer 12, the acquired first directory remains resident on server 42 while the user 10 manipulates or edits the same from their computer 12 via a suitable connection over the Internet 50 or other data network.

Having finished any desired updating, the first directory is uploaded to the server 42 (if previously downloaded therefrom). In response to a return instruction indicating the same, the updated first directory is forwarded from the server 42 to the OTAF server 60, optionally after reformatting it into the data structure used by the MS 20. The updated directory is then returned to the MS 20 by the OTAF server 60 sending a message to the MS 20 including the same.

Optionally, once the MS 20 has accepted the updated first directory, it responds to the OTAF server 60 with a message confirming the update. The confirmation is in turn routed back to the server 42 for presentation to the user 10.

In a similar manner, the first directory may be initially created on the MS 20. In this case, however, the aforementioned acquisition of the directory from the MS 20 may be omit insomuch as the directory would be empty anyhow. Rather, a newly created directory or the otherwise existing second directory on the computer 12 and/or server 42 is upload to the MS 20 from the computer 12 and/or server 42. Likewise, the first directory may simply be replaced or overwritten rather than being acquired and modified. See, e.g., FIG. 3 which shows an initial or replacement/overwriting data entry process 300. At step 302, the user 10 connects with the server 42 over the Internet 50 or other data network, and at step 304 the new or replacement directory data received by the server 42 from the user 10 is uploaded to the MS 20 via the OTAF server 60.

Referring again to FIG. 1, data entered in the first directory on the MS 20 is downloaded to and/or uploaded from the OTAF server 60, optionally, in two ways. In a first option, what is known as short message service (SMS) data protocol is used to route the data in messages between the OTAF server 60 and the MS 20. The messages in this case are routed via the MSC 28 through the network 22 and over the air interface 26 linking the BS 24 and the MS 20. In a second option, what is known as IP-based over-the-air provisioning (IOTAP) is used to route the data in Internet protocol (IP) based messages between the OTAF server 60 and the MS 20. The messages in this case are routed via the packet data network 50 and the PDSN 30 through the network 22 and over the air interface 26 linking the BS 24 and the MS 20.

While described with reference to an electronic telephone directory, it is also contemplated that other databases can be similarly provisioned, filled and/or managed, e.g., the electronic directory may be a “to do” or task list, address book, calendar or date book, memo pad or journal, expense report, etc. Likewise, applications themselves and/or other optional programming may be uploaded to the MS 20 in like fashion, e.g., games, ring tones, etc.

It is to be appreciated that particular elements or components described herein may have their functionality suitably implemented via hardware, software or a combination of hardware and software configurations. Additionally, it is to be appreciated that certain elements described herein as incorporated together may under suitable circumstances be stand alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method of updating data in an electronic database on a mobile station (MS), said method comprising:
(a) establishing a first connection with a user over a data network;
(b) receiving data to be entered into the electronic database from the user via the first connection;
(c) forwarding the received data to an over-the-air function (OTAF) server;
(d) establishing a second connection over a wireless air interface between the MS and a base station. (BS) of a cellular telecommunications network; and,
(e) transmitting the data from the OTAF server to the MS via the second connection such that the data is entered into the electronic database.

2. The method of claim 1, further comprising:
acquiring data in the database from the MS via the second connection, said acquired data being obtained by the OTAF server;
presenting the acquired data to the user via the first connection for selective modifying of the same by the user; and,
returning the selectively modified data to the database on the MS by steps (b) through (e).

3. The method of claim 2, wherein the presenting further comprises:
downloading the acquired data to the user over the first connection.

4. The method of claim 2, further comprising:
obtaining details about a data structure of the acquired data; and,
reformatting the acquired data from the data structure in which it was acquired to a specified data structure.

5. The method of claim 1, further comprising:
obtaining confirmation from the MS of the data being entered into the electronic database; and,
presenting the confirmation to the user.

6. The method of claim 1, wherein the electronic database is an electronic telephone directory.

7. The method of claim 1, wherein the MS is a mobile telephone or a mobile personal digital assistant (PDA).

8. A system for updating data in an electronic database on a mobile station (MS), said system comprising:
receiving means for receiving from a user data to be entered into the electronic database, said data being received via a first connection established with the user over a data network;
an over-the-air function (OTAF) server in operative communication with the receiving means, said receiving means forwarding the received data to the OTAF server; and,
a cellular telecommunications network including a base station (BS), said cellular telecommunications network establishing a second connection over a wireless air interface between the MS and the BS;
wherein the data is transmitted from the OTAF server to the MS via the second connection such that the data is entered into the electronic database.

9. The system of claim 8, wherein the electronic database is an electronic telephone directory.

10. The system of claim 8, wherein the MS is a mobile telephone or a mobile personal digital assistant (PDA).

11. The system of claim 8, wherein the receiving means is a web server.

12. The system of claim 11, wherein the data network is the Internet.

13. The system of claim 8, further comprising:
formatting means for formatting the received data into a data structure matching that of the electronic database.

14. The system of claim 8, wherein the OTAF server acquires data from the electronic database on the MS, said system further comprising:
means for presenting the acquired data to the user for selective modification of the same thereby.

15. A method of maintaining an electronic directory on a mobile station (MS), said method comprising:
obtaining data in the electronic directory from the MS via a wireless air interface between the MS and a base station (BS) of a wireless telecommunications network;
providing the obtained data for selective modification; and,
returning the selectively modified data to the MS via the wireless air interface between the MS and the BS of the wireless telecommunications network such that the returned data is entered into the electronic database.

16. The method of claim 15, wherein the electronic directory is an electronic telephone directory.

17. The method of claim 16, wherein the MS is a mobile telephone or a mobile personal digital assistant (PDA).
